(19) United States
(12) Patent Application Publication
(10) Pub. No.: US 2006/0041207 A1
(43) Pub. Date: Feb. 23, 2006

(54) Electrical heat and vibrating device

(76) Inventor: Julia Gross, Memphis, TN (US)

Correspondence Address: Julia Gross, 2033 Warren Street, Memphis, TN, 38106, US

(21) Appl. No.: 10/842,812

(22) Filed: Aug. 4, 2004

(51) Int. Cl. A61H 1/00

(52) U.S. Cl. 601/15; 601/46; 601/72

(57) ABSTRACT

The Electrical Heat and Vibrating Device is a lightweight, portable, completely self-contained low voltage, and self-administered therapeutic apparatus. More particularly, this invention gives the wearer or user comforting sensations to facilitate a temporary reduction in joint stiffness, joint pain, and joint discomfort, within the human body.

### BACKGROUND OF THE INVENTION

There is a need for a combined heating and vibrating apparatus that is portable and provided temporary pain relief to sufferers of inflammation of the joints, such as arthritis.

Many people who have problems (reactions) obtaining temporary relief through drugs are very good candidates for temporary relief supplied by mechanical devices.

Lack of portability and lack of self-administration were key problems past mechanical devices. This invention overcomes both of the above problems by drastically reducing the amount of heat needed and by providing a system that a patient can self-administer treatments as needed.

By incorporating several previous inventions into one single device, this invention introduces a new class of devices that promotes self-administration, portability, lightweight, and monitoring.

French patent 645,147 provided temporary relief by increasing blood flow through heat and massage therapy but it lacked key features of self-administration by the patient and portability.

U.S. Pat. Nos. 5,601,529, 1,498,680, and 5,577,273 offers temporary relief for aching muscles but fails to offer self-administration. These devices require a second person. Further, these devices fail to increase blood flow.

U.S. Pat. No. 4,979, 502 offers temporary relief for aching muscles but fails to deliver to maximum relief to body joints. It fails to trap maximum heat at the joints. Further, this device is heavy due to the large size batteries that are needed with the glove item. Further, the system would not be self-contained because batteries would have to be carried on the belt.

### SUMMARY OF THE INVENTION

The present invention incorporates several prior arts into a highly effective device that gives temporary relief to people suffering from inflammation of the joints thru heat and vibration therapy.

More particularly, this device is designed to be lightweight, portable, completely self-contained low voltage, and self-administered therapeutic apparatus. By utilizing a thermodynamic gloving system to retain heat, the device only needs to raise the temperature of the hand slightly above regular body temperature in order to be effective. This allows for true portability and easy self-administration by the patient.

The inner glove acts as a heat sink. It provides rapid heat transference by utilizing materials that have a low resistance to heat such as silk, nylons, etc. The external glove acts as a heat resistor. It provides resistance to heat flow from the heating element attached to the inner glove. The exterior glove is made from material that has low thermal conductivity and/or has thermal insulation attached to it in order to increase the thermal resistance to heat flow—ex. Leather with a thick polyester backing.

Together, the therapeutic gloving system can be completely powered by a low voltage lightweight battery system—ex. Six (6) triple A batteries or a rechargeable battery pack.

The exterior glove has a built in pouch for the vibrator, a pouch for the battery pack, heater connector, and controls for the vibrator speed. The inner glove is made from any material—silk, nylon, etc—that allows for good heat transfer from the heating element to the hand of the person wearing it. The inner glove is washable if two separate gloves are used in construction. Each glove finger of the inner glove has a split in the bottom so each fingertip can be removed and visually checked. The heating element is bonded to the outside of the inner glove with suitable waterproof thermal adhesive or can be sewn on by today's available manufacturing methods.

The glove design has a built in split at the bottom of each fingertip of the external glove. This aids in visually inspecting fingertips. Alternatively, the fingertips of the gloves can be designed to be removed with detachable tips.

The therapeutic system can be strapped to the wearer's hand with a VELCO type of strap or the glove can fit the wearer's hand snuggly and achieve the desired effects from the operation of the vibrator and heater.

The heating element is composed of a bare strip heater. It is attached to a conductor, which is connected to a low voltage source inside of the exterior glove pouch.

Since heat is trapped within the glove system, it is only necessary for the heater to operate at ½ of 1 degree above the wearer's skin temperature in order to provide the needed therapeutic relief.

### BRIEF DESCRIPTION OF THE DRAWINGS

FIG. 1 illustrates a top view of the exterior of the therapeutic system.

FIG 1A illustrates a cross sectional view of the thumb in FIG. 1;

FIG. 2 illustrates the palm side of the therapeutic system in FIG. 1

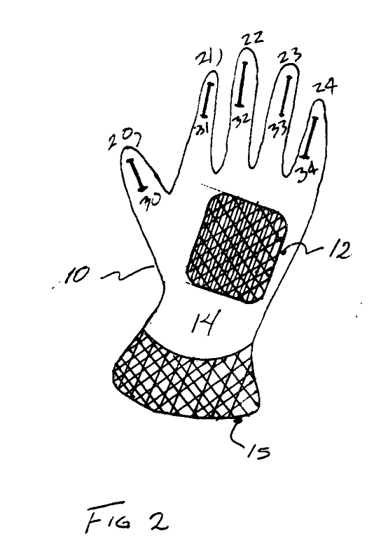

FIG. 3 illustrates the top of the interior glove used in the therapeutic system of FIG. 1.

FIG. 4 illustrates the control circuit used to operate the therapeutic system in FIG. 1.

### DETAILED DESCRIPTION OF THE PREFERRED INVENTION

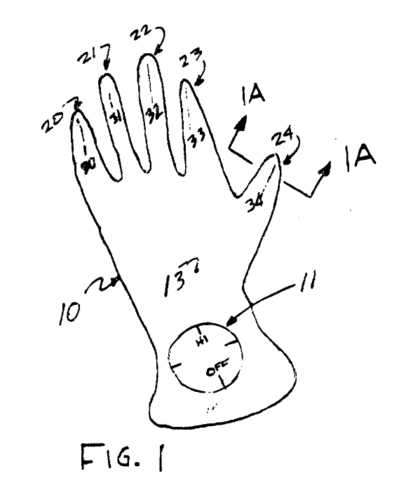

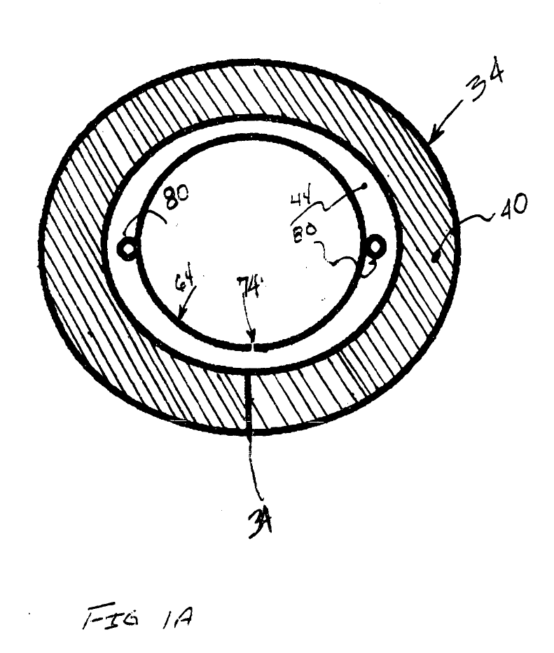

With reference to FIG. 1, 1A and 2, the therapeutic glove system 10 has slits 30, 31, 32, 33, 34 on the bottom 14 of exterior fingers 20, 21, 22, 23, 24. The exterior skin 13 of the therapeutic glove 10 is lined with insulation 40 to retain heat within the therapeutic system. A vibrator controller 11 is built on top of the exterior skin 13. The palm side 14 of glove 10 houses the pocket 12 for a vibrator motor and the pocket 15 for the battery pack 90.

With reference to FIG. 1A, a cross-sectional area of thumb shows the thermodynamic workings of the glove. The exterior skin 13 is attached to insulation in order to retard heat flow to the outside of the glove system 10. An air gap 41 serves as a stagnant air barrier to further retard heat flow to the exterior of glove system 10. Strip heater 80 loops around the top of the interior glove 50 thereby transferring heat to a hand that is cooler than the heater

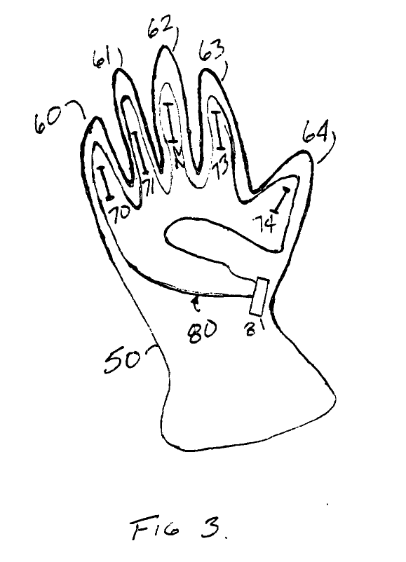

With reference to FIG. 3, the internal glove skin 50 distributes heat and slightly raises the temperature of the hand. The bottom of the internal glove fingers 60, 61, 62, 63, 64 have slits 70, 71, 72, 73, 74 for visual inspection of the fingertips. A strip heater 80 is bonded to the top of the internal glove skin with a waterproof adhesive or can be sewn on. The strip heater 80 terminates at a conductor block 81. This conductor blocks 81 which delivers current to the strip heater 80.

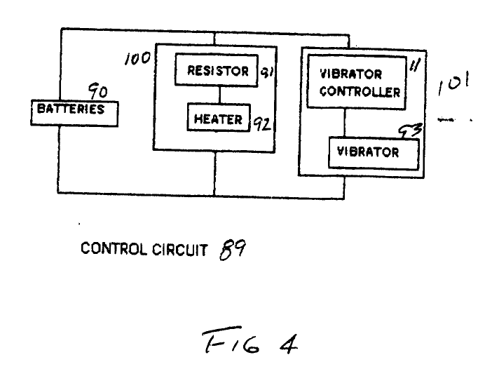

With reference to FIG. 4, the therapeutic glove system 10 is wired according to control circuit 89. The battery pack 90 forms two parallel circuits 100 and 101. Circuit 100 is a series circuit composed of a resistor 91 and a strip heater 92. Circuit 101 is a series circuit composed of a vibrator controller 11 and a vibrating motor 93. Resistor 91 limits the amount of current flowing into the strip heater 92. The vibrator controller 11 controls the intensity of the vibrator.

1. I Julia Gross, the inventor, claim the Electrical Heat and Vibrating Device helps relieve the symptoms: pain, swelling, and stiffness around the joints with a vibrating and heat sensation over the inflame area.
This device is unique, portable lightweight, and has a completely self-contained low voltage.
It's a self-administered therapeutic apparatus and can be used while driving and playing sports because it can be operated by batteries.
It's not time consuming and has a removable lining for easy cleaning.
The device itself is a great way to stay moveable without being in pain.
There are more perks to this device; as stated above it has a removable lining: the outer layer is leather to contain the heat if the heating element is turned off and most importantly the lining is moisture resistance and heat retardant for safety.
Alternatively, the fingertips of the gloves are designed to be removed with detachable tips to aid in visually inspecting fingertips.
The glove device can fit the wearer's hand snuggly and achieve the desired effects from the operation of the vibrator and heater.
